(19) United States
(12) Patent Application Publication
(10) Pub. No.: US 2026/0343367 A1
(43) Pub. Date: Oct. 29, 2026

(54) FAST FAILURE RECOVERY WHILE USER EQUIPMENT CONFIGURED WITH LEVEL 1 OR LEVEL 2 TRIGGERED MOBILITY

(71) Applicant: TELEFONAKTIEBOLAGET LM ERICSSON (PUBL), Stockholm (SE)

(72) Inventors: Pontus WALLENTIN, LINKÖPING (SE); Icaro Leonardo DA SILVA, SOLNA (SE); Antonino ORSINO, Kirkkonummi (FI); Stefan WAGER, Espoo (FI)

(73) Assignee: TELEFONAKTIEBOLAGET LM ERICSSON (PUBL), Stockholm (SE)

(21) Appl. No.: 19/482,020

(22) PCT Filed: May 13, 2024
(86) PCT No.: PCT/SE2024/050456

§ 371 Date: Nov. 6, 2025

Related U.S. Application Data
(60) Provisional application No. 63/465,694, filed on May 11, 2023.

(51) Int. Cl. H04W 36/30; H04W 36/00; H04W 36/04

(52) U.S. Cl. CPC H04W 36/305; H04W 36/0061; H04W 36/04

(57) ABSTRACT

A method is provided performed by a user equipment, UE, to perform recovery from a radio related failure. The method includes receiving and storing in the UE at least one Level-1, L1, or Level-2, L2, triggered mobility, LTM, candidate cell configuration; detecting the radio related failure; performing cell selection responsive to detecting the radio related failure; determining whether the selected cell corresponds to one of the stored at least one LTM candidate cell configuration; and responsive to the selected cell corresponding to one of the stored at least one LTM candidate cell configuration, applying the stored LTM candidate cell configuration corresponding to the selected cell as a target cell.

### TECHNICAL FIELD

The present disclosure relates generally to wireless communications, and more particularly to communication methods and related devices and nodes supporting wireless communications.

### BACKGROUND

When a user equipment (UE) moves from the coverage area of one cell to another cell, at some point a serving cell change may need to be performed. As defined in Third Generation Partnership Project (3GPP) Release 17 or earlier, a serving cell change may be triggered by layer 3 (L3) measurements and may utilize radio resource control (RRC) signalling triggered reconfiguration with synchronisation for change of primary cell (PCell) and primary secondary cell (PSCell), as well as releasing and adding secondary cells (SCells) when applicable. Such a serving cell change may involve layer 2 (L2) (and layer 1 (L1)) resets, leading to longer latency, larger overhead, and longer interruption time than beam switch mobility. In 3GPP Release 18, a concept known as L1/L2 triggered mobility (LTM), also known as lower layer triggered mobility, was introduced. LTM can enable a serving cell change via L1/L2 signalling, in an effort to reduce the latency, overhead, and interruption time. However, issues and/or challenges exist with utilizing LTM including fast failure recovery while a UE is configured with LTM.

### SUMMARY

Some embodiments are directed to a method performed by a user equipment, UE, to perform recovery from a radio related failure. The method includes receiving and storing in the UE at least one Level-1, L1, or Level-2, L2, triggered mobility, LTM, candidate cell configuration; detecting the radio related failure; performing cell selection responsive to detecting the radio related failure; determining whether the selected cell corresponds to one of the stored at least one LTM candidate cell configuration; and responsive to the selected cell corresponding to one of the stored at least one LTM candidate cell configuration, applying the stored LTM candidate cell configuration corresponding to the selected cell as a target cell.

Some embodiments are directed to methods for a UE to perform recovery from a radio related failure when the UE is configured with one or more LTM candidate cell configurations. Upon detecting the radio related failure, the UE performs cell selection to find a suitable cell to re-establish connectivity. Once a suitable cell is found, the UE determines whether it has a stored LTM candidate cell configuration associated with this selected cell. If so, the UE applies this stored LTM candidate cell configuration associated with the selected cell.

In addition, some further embodiments are directed to methods for the UE to obtain the information needed to access the target (selected) cell, also referred to as dynamic information. Part of this information is normally received in the medium access control (MAC) control element (CE) from the source cell triggering the LTM cell switch, but the UE may not receive this information in case of radio related failure. This information includes, e.g., whether the UE may access the target cell without random access if the UE has a valid timing advance (TA), and if so what transmission configuration information (TCI) states to apply, which uplink (UL) grant to use, bandwidth part (BWP) to use, etc. To conclude, the procedure the UE performs the access in the target cell using the obtained information for accessing the target cell and transmits a notification message to the target node to inform of the successful recovery.

Some further embodiments are directed to inter node signaling for notifying the central unit (CU) of successful failure recovery and CU notifying the source distributed unit (DU) and sometimes, such when the UE recovered during an LTM cell switch procedure, also notifying a first target DU.

Certain embodiments may provide one or more of the following technical advantage(s). Some of the embodiments disclosed herein may enable the UE configured with L1/L2-triggered mobility, when a radio related failure occurs, to perform a fast recovery from the failure. Further, some embodiments may enable the UE to, during the recovery, perform an LTM cell switch towards a selected target cell which is configured as an LTM candidate cell and use obtained dynamic information about the target cell to reduce the interruption time by avoiding the steps to establish downlink (DL) sync and/or random access.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating a system structure in accordance with some embodiments;

FIG. 2 is a message sequence diagram associated with a radio related failure in accordance with some embodiments;

FIG. 3 is a message sequence diagram associated with a level-1 (L1)/level-2 (L2) triggered mobility (LTM) cell switch procedure in accordance with some embodiments;

FIG. 4 is a flowchart illustrating operations performed by a user equipment (UE) in accordance with some embodiments;

FIG. 5 is a flowchart illustrating an example method performed by a UE in accordance with some embodiments;

FIG. 6 is a flowchart illustrating an example method performed by a source network node in accordance with some embodiments;

FIG. 7 is a block diagram of a communication system in accordance with some embodiments;

FIG. 8 is a block diagram of a user equipment in accordance with some embodiments;

FIG. 9 is a block diagram of a network node in accordance with some embodiments;

FIG. 10 is a block diagram of a host computer communicating with a user equipment in accordance with some embodiments;

FIG. 11 is a block diagram of a virtualization environment in accordance with some embodiments; and

FIG. 12 is a block diagram of a host computer communicating via a base station with a user equipment over a partially wireless connection in accordance with some embodiments in accordance with some embodiments.

### DETAILED DESCRIPTION

Level-1 (L1)/Level-2 (L2) Triggered Mobility (LTM) in Release 18 (Rel-18) In Third Generation Partnership Project (3GPP) Release 18, a work item known as Further NR mobility enhancements has been agreed. This work item includes a technical area entitled L1/L2 based inter-cell mobility. According to the Work Item Description (WID) [1] RP-223520, 3GPP work item description: Further NR mobility enhancements, MediaTek Inc, Apple, 3GPP Technical Specification Group (TSG) Radio Access Network (RAN) Meeting #98-e, Electronic Meeting, December 12-16, 2022 (hereinafter “WID[1]”), when the UE moves from the coverage area of one cell to another cell, at some point a serving cell change needs to be performed. Currently serving cell change is triggered by level-3 (L3) measurements and is done by radio resource control (RRC) signalling triggered Reconfiguration with Synchronisation for change of primary cell (PCell) and primary secondary cell (PSCell), as well as releasing and adding secondary cells (SCells) when applicable. Such cases may involve complete L2 (and L1) resets, leading to longer latency, larger overhead and longer interruption time than beam switch mobility. The goal of L1/L2 based inter-cell mobility is to enable a serving cell change via L1/L2 signalling, in order to reduce the latency, overhead and interruption time.

In this work item, according to WID [1], the following is included as one objective of the work:

```
1. To specify mechanism and procedures of L1/L2 based inter-cell mobility for mobility
  latency reduction:
  ○ Configuration and maintenance for multiple candidate cells to allow fast
      application of configurations for candidate cells [RAN2, RAN3]
  ○ Dynamic switch mechanism among candidate serving cells (including special cell
      (SpCell) and SCell) for the potential applicable scenarios based on L1/L2
      signalling [RAN2, RAN1]
  ○ L1 enhancements for inter-cell beam management, including L1 measurement and
      reporting, and beam indication [RAN1, RAN2]
      - Note 1: Early RAN2 involvement is necessary, including the possibility of
        further clarifying the interaction between this bullet with the previous bullet
  ○ Timing Advance management [RAN1, RAN2]
  ○ Central unit (CU)-distributed unit (DU) interface signaling to support L1/L2
      mobility, if needed [RAN3]
  Note 2: Frequency range (FR)2 specific enhancements are not precluded, if any.
  Note 3: The procedure of L1/L2 based inter-cell mobility are applicable to the following
  scenarios:
  ▪ Standalone, carrier aggregation (CA)and next radio (NR)-dual connectivity
      (DC) case with serving cell change within one configured grant (CG)
  ▪ Intra-DU case and intra-CU inter-DU case (applicable for Standalone and CA:
      no new RAN interfaces are expected)
  ▪ Both intra-frequency and inter-frequency
  ▪ Both FR1 and FR2
  ▪ Source and target cells may be synchronized or non-synchronized
```

In 3GPP, discussions have started on solutions for L1/L2 based inter-cell mobility (sometimes also referred to as LTM, L1/L2-triggered mobility, or lower layer-triggered mobility).

A basic principle with L1/L2-triggered mobility is that the UE is pre-configured, by the network, with an RRC configuration per LTM candidate cell, sometimes also known as a LTM candidate cell configuration. Such a LTM candidate cell configuration may be an RRCReconfiguration message or one or more information elements (IEs)/fields/parameters such as CellGroupConfig. The UE performs measurements on these LTM candidate cells and transmits corresponding measurement reports to the network. The network then triggers the execution of a LTM cell switch procedure in the UE by transmitting a lower layer signal (such as a medium access control (MAC) control element CE or downlink control information (DCI)), sometimes also referred to as a LTM cell switch command, to the UE, which then connects to the target cell and switches to a LTM candidate cell configuration.

At the 3GPP meetings, there were multiple agreements made on L1/L2-triggered mobility, and among these are the following:

Following behaviors of LTM supervisor timer are agreed:

```
  - 1: the UE starts the LTM supervisor timer, upon reception of the LTM cell switch MAC
  CE;
  - 2: the UE stops the LTM supervisor timer, upon successful completion of LTM cell
  switch;
  - 3: if the LTM supervisor timer for master cell group (MCG) expires, as baseline, the UE
  considers LTM failure and initiates RRC re-establishment. (secondary cell group (SCG)
  switch case for further study (FFS)).
At radio link failure (RLF) or LTM execution failure (for MCG), RAN2 intend to support fast
recovery to a candidate cell by LTM execution.
```

### Agreement

For the Release 17 (Rel-17) unified transmission control information (TCI) based beam indication in Rel-18 LTM, at least alternate (Alt) 1 is supported:

```
○ Alt 1: TCI state activation of a candidate cell is received before the reception of
        beam indication of the candidate cell,
○ Alt 2: TCI state activation of a candidate cell is received together with the reception
        of beam indication of the candidate cell
        - FFS: signalling details for TCI state indication, if both activation and
            indication are done in the same MAC CE message carrying switch command
○ Alt 3: Alt 1 and/or Alt 2 can be supported based on the UE capability.
FFS: signalling details for TCI state activation.
FFS: For Alt 1, whether/how TCI state activation for candidate cell(s) is allowed.
Note: If scenarios 1 and 3 are to be supported other beam indication/TCI activation timing
relationships are not precluded.
```

There currently exist certain challenge(s).

Many details of the procedures for L1/L2-triggered mobility (LTM) are still open in 3GPP.

One aspect that has not yet been agreed on is failure recovery. In the RAN2 #121bis meeting there was a high level agreement to support fast recovery to a candidate cell by LTM execution, but no details have been agreed on yet.

Similar functionality is already supported for UEs configured with Conditional Handover (CHO), where after RLF detection and subsequent cell selection, if the selected cell is a target candidate cell, the UE shall apply the stored CHO configuration it has for that cell. Whether the UE shall apply the configuration or not is controlled by the network using the field attemptCondReconfig, see field description below.

```
⇒ attemptCondReconfig
⇒ If present, the UE shall perform conditional reconfiguration if selected cell is a target
  candidate cell and it is the first cell selection after failure as described in clause 5.3.7.3
  of 3GPP RRC specification, TS 38.331 v17.4.0, March 2023.
```

Similar functionality can be considered also for LTM in order to facilitate the fast recovery from RLF or execution failure. Also, LTM relies on the network providing a RRC configuration for each candidate target cell to the UE in advance, which is later applied by the UE upon LTM execution. There are however several differences between CHO and LTM when it comes to the configuration and execution, which need to be solved in order for this to work. For instance, LTM supports downlink (DL) and uplink (UL) pre-synchronization with LTM candidate target cells, and to reduce the interruption time during LTM execution by avoiding e.g., random access with the target. LTM also supports a larger flexibility in terms of user plane handling, where the network can control which protocol layers that are reset or re-established.

An important component of the LTM execution is the dynamic information included in the LTM command, which is provided in a MAC CE sent from the source cell triggering the LTM to the target cell. For the failure case, the network will not be able to provide the UE with this information, as the UE has lost the connectivity with the source cell. Thus, for the failure recovery case, it needs to be specified how the UE applies the LTM configuration without this dynamic information. The content of the dynamic information is still being discussed, but the following have been discussed:
LTM candidate configuration identifier (ID)
TCI state
bandwidth part (BWP) ID
timing advance (TA)
UL grant.

Certain aspects of the present disclosure may provide solutions to these or other challenges.

Some of the embodiments contemplated herein will now be described more fully with reference to the accompanying drawings. Embodiments are provided by way of example to convey the scope of the subject matter to those skilled in the art.

The text refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility L1/L2-Triggered Mobility, Lower-layer triggered Mobility or LTM. Accordingly, each use of one of these terms in the description herein may be substituted with any of these other interchanging terms. The basic principle of various embodiments is that the UE receives a lower layer signaling from the network indicating to the UE a change (or switch or activation) of its serving cell (e.g., change of PCell, from a source to a target PCell), wherein a lower layer signaling is a message/signaling of a lower layer protocol, which may be referred as a L1/L2 inter-cell mobility execution command or LTM cell switch command. The change of serving cell (e.g., change of PCell) may also lead to a change in Scell(s) for the same cell group e.g., in case the command triggers the UE to change to another cell group configuration of the same type (e.g., another MCG configuration). Before the UE receives the LTM cell switch command, the UE is configured by the network with one or more LTM candidate cell configurations (e.g., reception of an RRC Reconfiguration message, with at least one LTM candidate cell configuration) A LTM candidate cell configuration may include parameters in the IE CellGroupConfig per candidate cell and/or an embedded RRC Reconfiguration per LTM candidate cell.

The term LTM cell switch procedure refers to the process of a UE switching (or changing) its cell from a source cell to a target cell (which may be called here an LTM candidate cell or a neighbour cell), using L1/L2-triggered mobility (LTM). In the context of L1/L2-triggered mobility (LTM), an LTM cell switch procedure may sometimes also be known as L1/L2 based inter-cell mobility execution, LTM execution, dynamic switch, LTM switch, (LTM) cell switch, (LTM) serving cell change or (LTM) cell change. In the context of the some embodiments, switching to the LTM candidate cell configuration comprises the UE considering that an LTM candidate cell becomes its new special cell (SpCell) e.g., PCell in case of LTM being configured for a Master Cell Group (MCG) and/or PSCell in case of LTM being configured for a Secondary Cell Group (SCG); or, changing its SpCell from the current PCell to an LTM candidate cell.

Even if the term change of cell is used, that may comprise a change of a whole cell group configuration, which includes a change in the SpCell (e.g., change of PCell, or change of PSCell) and a change in SCells of the cell group (e.g., addition, modification and/or release of one or more SCells).

An LTM cell switch procedure may be triggered in the UE by reception of a LTM cell switch command, or alternatively, triggered by some other event, such as a condition, e.g., a triggering condition used for conditional configuration, such as conditional handover, being fulfilled, as a result of recovery from radio link failure or handover failure.

The text refers to a LTM candidate cell, which is a cell the UE is configured with when configured with L1/L2-triggered mobility. That is a cell the UE can move to in a LTM cell switch procedure, upon reception of a LTM cell switch command. These cells may also be called candidate cell(s), candidates, mobility candidates, non-serving cells, additional cells, target candidate cell, target candidate, etc. A LTM candidate cell is a cell the UE perform measurements on (e.g., channel state information (CSI) measurements) so that the UE reports these measurements and network may take educated decision on which beam (e.g., TCI state) and/or cell the UE is to be switched to. An LTM candidate cell may be a candidate to be a target PCell or PSCell, or an SCell of a cell group (e.g., MCG SCell).

The text refers to at least one LTM candidate cell configuration and that the UE has received at least one LTM candidate cell configuration. This is also sometimes referred to as a configuration of a LTM candidate cell, which may be an RRC configuration, such as encapsulated in an RRC Reconfiguration message, that the UE receives when being configured with L1/L2-Triggered Mobility. A LTM candidate cell configuration comprises the configuration which the UE needs to start to operate accordingly when it performs an LTM cell switch procedure to that LTM candidate cell e.g., upon reception of the LTM cell switch command indicating the UE to perform a LTM cell switch procedure to that LTM candidate cell, which becomes the target cell and the current (new) SpCell, or an SCell in a serving frequency. The LTM candidate cell configuration comprises parameters of a serving cell (or multiple serving cells, such as a cell group), comprising one or more of the groups of parameters, such as an RRCReconfiguration message an IE CellGroupConfig or an IE SpCellConfig (or the IE SCellConfig, in the case of a Secondary Cell). A LTM candidate cell configuration may in one example comprise one or more of: i) the PCell configuration and one or more SCell configuration(s) of a Master Cell Group (MCG); i) the PSCell configuration and one or more SCell configuration(s) of a secondary Cell Group (SCG). The terms (LTM) candidate configuration, LTM configuration, (LTM) candidate target cell configuration, (LTM) target candidate (cell) configuration may be used interchangeably when referring to LTM candidate cell configuration. An LTM candidate cell configuration is associated with an identifier which is used in the signaling when referring to a certain LTM candidate cell configuration, such as when the UE receives the LTM candidate cell configuration and when the UE receives an LTM cell switch command indicating the UE to perform a LTM cell switch procedure to that LTM candidate cell. This identifier is sometimes known as the LTM candidate cell configuration identity or LTM candidate configuration index (or similar).

The actual LTM candidate cell configuration and its exact content and/or structure of this IE and/or embedded message may be called an RRC model for the candidate configuration, or simply RRC model. An LTM candidate cell configuration comprises the configuration which the UE needs to operate accordingly when it performs (executes) L1/L2 based inter-cell mobility execution to a LTM candidate cell, upon reception of the lower layer signaling (MAC CE) indicating a L1/L2 based inter-cell mobility to a LTM candidate cell (which becomes the target cell and the current (new) PCell, or an SCell in a serving frequency), or upon reception of the lower layer signaling (MAC CE) indicating a L1/L2 based inter-cell mobility to a LTM candidate cell configuration indicated with a candidate configuration index (sometimes also denoted candidate configuration ID). The UE may be configured with multiple LTM candidate cell configurations, so a Candidate DU generates and sends to the CU multiple configuration(s). The actual LTM candidate cell configuration the UE receives during the LTM configuration may be a delta signaling to be applied on top of a reference configuration, so that the actual configuration the UE is to use in the candidate cell upon LTM cell switch is the combination of the LTM candidate cell configuration and the reference configuration (e.g., separately signaled by the network to the UE).

The term “beam” may correspond to a spatial direction in which a signal is transmitted (e.g., by a network node) or received (e.g., by the UE), or a spatial filter applied to a signal which is transmitted or received. Thus, transmitting signals using different beams could correspond to transmitting signals in different spatial directions. When the text refers to a “beam which is selected” it may refer to a beam index and/or a Reference Signal (RS) index or identifier, such as a Synchronization Signal block (SSB) index, or a CSI-RS resource identifier. Thus, selecting a beam may correspond to selecting an SSB, associated to an SSB index. Or, selecting a beam may correspond to selecting a CSI-RS, associated to a CSI-RS resource identifier.

The text refers to the phrase radio related failure. A radio related failure may be triggered for the Master Cell Group (MCG) or the Secondary Cell Group (SCG) and may be one of:
a beam failure detection (BFD), e.g., as defined in 3GPP TS 38.321;
a failure to execute a LTM cell switch procedure, e.g., expiry of the LTM; supervision timer, expiry of a timer T304 associated to an LTM candidate cell;
a handover failure (HOF), e.g., expiry of timer T304;
a radio link failure (RLF), e.g., expiry of timer T310 or T316; or
a failure to (re)transmit a maximum number N of radio link control (RLC) protocol data unit (PDU).

The phrase information for accessing the target cell refers to information the UE use to how to perform access in the target cell, e.g., determine whether a random access is needed or not, or whether it can start UL transmission without performing scheduling request, which beam to use, whether the UE has downlink sync, etc. when performing access in the cell. Parts of this information may be referred to as “dynamic information” while may be valid for a limited time or meant only to be used for a single access and by this UE. The information for accessing the target cell may include information such as:
UL or DL TCI states;
SSB index(s);
CSI-RS resource identifier(s);
active BWP ID;
TA;
UL grant;
L1 measurements;
state of DL synchronization (in synch, out of sync, etc.);
whether the cell is known or unknown;
TA timer status (running/not running);
indication whether random access is needed to access the target cell;
indication whether an L2 reset (e.g., MAC reset, partial MAC reset, RLC re-establishment or packet data convergence protocol (PDCP) data recovery) is needed or not when performing an LTM cell switch towards the target cell;
LTM candidate configuration ID.

The information for accessing the target cell may be received by the UE in a MAC CE, such as an LTM cell switch command, TA command, random access response (RAR), in a beam indication or a TCI state activation, or in the physical layer, such as in Downlink Control Information or a physical downlink control channel (PDCCH) order, or in the RRC signalling such as in an LTM candidate cell configuration or sent in an RRCReconfiguration message or a system information block.

A system overview is now discussed herein.

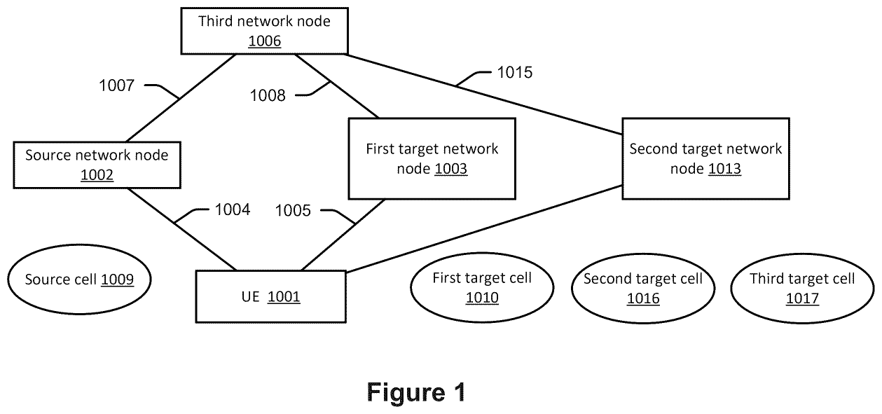

FIG. 1 illustrates a system structure including the entities involved in some embodiments. The User Equipment (UE) 1001 is a wireless terminal, such as a cellular smartphone, sometimes connected to the source network node 1002 over a wireless interface 1004 and sometimes, such as a result of mobility, connected to a first target network node 1003, to which the UE 1001 is connected over a wireless interface 1005. In some cases, such as a result of mobility or a result of the UE performed failure recovery, the UE 1001 is connected to a second target network node 1013 over a wireless interface 1014.

In the context of a mobility procedure, such as a LTM cell switch procedure, for the UE, the source network node 1002, sometimes also referred to as the serving network node, controls a source cell 1009 (sometimes called serving cell or Special Cell (SpCell). The first target network node 1003 controls a first target cell 1010 (sometimes called target cell, neighbour cell, candidate cell or LTM candidate cell). In the context of a mobility procedure for the UE or when the UE performs failure recovery, the second target network node 1013 controls a second target cell 1016 and sometimes controls a third target cell 1017.

Each of source network node 1002, the first target network node 1003 and the second target network node 1013 may be a base station such as e.g., a base station in NR (gNB), or, e.g., in case of a distributed CU/DU RAN architecture, a distributed unit, sometimes known as either gNB-DU or DU. Hence the source network node 1002 corresponds to a source DU, S-DU, sometimes also known as serving DU, the first target network node 1003 corresponds to a target DU, T-DU, and the second target network node 1013 corresponds to a second target DU. A first or second target DU is sometimes called neighbour DU or candidate DU (C-DU).

The source network node 1002, the first target network node 1003 and the second target network node 1013 are all connected to a third network node 1006, sometime also referred to as serving network node. The source network node and either of the first or second target network nodes may be the same network node. In some scenarios the source network node and either of the first or second target network nodes may be connected to different third network nodes 1006.

Further, the third network node 1006 may (e.g., in case of a distributed CU/DU RAN architecture) be a central unit (CU) sometimes referred to as the serving CU, known as either a gNB-CU, a CU, a gNB-CU control plane (gNB-CU-CP), or a gNB-CU user plane (gNB-CU-UP); or a core network node such as an User Plane Function (UPF); or an Access and Mobility management Function (AMF).

Some embodiments present methods for a User Equipment (UE) (1001), to perform recovery from a radio related failure in a source cell (1009) or target cell (1010), comprising the UE:
receiving at least one LTM candidate cell configuration,
detecting a radio related failure,
performing cell selection,
determining whether the selected cell (1016) is one of LTM candidate cells for which the UE has a stored LTM candidate cell configuration,
when the selected cell (1016) is one of LTM candidate cells:
   applying the stored LTM candidate cell configuration associated to the selected cell (1016),
   obtain information for accessing the target cell (1016),
   performing access in the target cell (1016) using the obtained information for accessing the target cell,
   transmitting, to a network node (1013), a notification message.

In a dependent step, when upon cell selection the UE determines that the selected cell is NOT one of LTM candidate cells for which the UE has a stored LTM configuration, the UE performs a re-establishment procedure with the selected cell.

In a dependent step, when a radio related failure is detected (e.g., timer T304 expires, expiry of the LTM supervision timer, LTM execution failure detection, Radio Link Failure, etc.), the UE initiates a re-establishment procedure, starts timer T311 and starts cell selection and depending on the outcome of cell selection it determines whether to continue with the re-establishment procedure or to trigger an LTM execution to the selected cell. When the UE selects a cell for which it does not have a stored LTM configuration the UE continues with the re-establishment procedure with the selected cell and deletes/releases LTM related information e.g., LTM candidate cell configuration(s).

In a dependent step, when a radio related failure is detected (e.g., timer T304 expires, LTM execution failure detection, Radio Link Failure, etc.), the UE initiates a re-establishment procedure, starts timer T311 and starts cell selection and, depending on the outcome of cell selection, the UE determines whether to continue with the re-establishment procedure (e.g., whether to transmit an RRC Reestablishment Request message) or whether to trigger an LTM execution to the selected cell (e.g., whether to apply an LTM candidate cell configuration of the selected cell). When the UE selects a cell for which it has a stored LTM configuration the UE executes the LTM cell switch and, when that LTM execution also fails, the UE re-initiates a re-establishment procedure and continues with the re-establishment procedure, i.e., without the possibility to execute LTM cell switch again. When that second re-establishment initiation happen, the UE deletes/releases the related LTM configuration(s) before cell selection while timer T311 is running, so that when a cell is selected it may not be a cell for which the UE has stored LTM configuration(s). Thanks to this mechanism the UE is only allowed to try once to execute LTM on a selected LTM candidate cell after the failure once.

In a dependent step, when a radio related failure is detected (e.g., timer T304 expires, LTM execution failure detection, Radio Link Failure, etc.), the UE initiates a re-establishment procedure, starts timer T311 and starts cell selection and, depending on the outcome of cell selection, the UE determines whether to continue with the re-establishment procedure (e.g., whether to transmit an RRC Reestablishment Request message) or whether to trigger an LTM execution to the selected cell (e.g., whether to apply an LTM candidate cell configuration for the selected cell). When the UE selects a cell for which it has a stored LTM configuration the UE executes the LTM cell switch and, when that LTM execution also fails, the UE re-initiates a re-establishment procedure and determines to continue or not with the re-establishment procedure, i.e., without the possibility to execute LTM cell switch again, based on a counter value which is incremented every time the UE performs an LTM execution in response to a cell selection after a detected radio related failure. Thanks to that mechanism the UE is only allowed to try a limited number of times to execute LTM on a selected LTM candidate cell after the radio related failure once. In one option, the maximum counter value is configured by the network to the UE, e.g., as part of the LTM configuration, possibly per LTM candidate cell, or a maximum value regardless of the LTM candidate cell.

In one option, even when the UE is allowed to try an LTM execution on a selected cell upon a radio related failure detection multiple times, that is only allowed to be done once per LTM candidate cell. For example, if the UE selects cell A and the UE has a stored LTM candidate cell configuration for cell A, and that LTM execution fails, the UE can select a cell B, and if that fails, and the UE selects cell A again, the UE is not allowed to trigger the LTM execution to cell Am, even if the counter value would have not reached its maximum value. In other words, when the UE selects a cell and that is an LTM candidate cell for which the UE has a stored LTM candidate configuration, the UE applies the LTM candidate configuration (i.e. executes LTM to the selected cell) only when that cell has not been previously selected since the counter started to get incremented.

In methods, obtaining the information for accessing the target cell may include one or more of the following steps.
If the UE has a valid Timing Advance (TA) value for the selected candidate cell, it accesses the target cell without random access e.g., if a Time Alignment timer is running for the selected candidate and/or if the UE has received a TA value in the LTM cell switch command. If the UE does not have a valid TA for the selected candidate cell (e.g., Time Alignment timer has expired and/or the TA value was not received by the UE for the selected LTM candidate cell) the UE triggers random access in the target cell.
In another embodiment to improve robustness, the UE triggers the random access in the selected target cell regardless of whether it has a valid TA, or not. As part of that process, the UE releases TA information it may have for the selected LTM candidate cell and/or other configured LTM candidate cell(s). In one option, when the UE accesses the selected target cell after the failure with random access the UE resets the MAC entity.
For the case where the UE access the selected cell without random access, i.e. the TA is valid, the UE uses the TCI state previously used to perform the early DL synchronization (e.g., a previously indicated TCI state), such as when the UE has received a TCI state activation of a candidate cell before the reception of LTM cell switch command and/or beam indication of the candidate cell. In another embodiment, the TCI state for fast failure recovery may be part of the LTM candidate cell configuration.
In order to support a fast recovery procedure in case of LTM RLF, a dedicated fast recovery configuration may be included within the LTM candidate cell configuration and the UE is allowed to use such configuration only when an LTM execution failure is detected. In another embodiment the UE is allowed to use the recovery configuration after detecting RLF on the serving cell or any other radio related failure and then selecting a cell for which the UE has a stored LTM configuration. The dedicated fast recovery configuration may include one or more of the following items for fast recovery:
   UL and DL TCI states
   UL grant for fast
   active BWP ID
   an indication whether the UE is allowed to access the candidate cell without random access (for the case that TA is valid)
   random access configuration, for the case that TA is not valid
   TA information.
If the UE fails to execute the LTM without random access, it may trigger LTM with random access to the same selected cell.
If the UE fails to execute the LTM without random access, it may consider the selected cell as a “normal cell” and it may initiate the random access procedure without considering any LTM configuration for that particular cell.
If the UE fails to execute the LTM with random access, it may trigger RRC re-establishment.
The UE may decide the L2 actions based on the contents of the LTM configuration associated to the selected cell. L2 actions here may include whether to re-establish RLC and whether to perform full or partial or no MAC reset. In another embodiment to improve robustness, the UE triggers RLC re-establishment and MAC reset regardless of the indications in the LTM candidate configuration associated to the selected cell.
In one embodiment, the UE selects the BWP in the selected cell based on the firstActiveDownlinkBWP-Id/firstActive UplinkBWP-Id fields included in the LTM candidate configuration associated to the selected cell. If these fields are absent (since the BWP-Id can in the normal case be included in the LTM MAC CE), the UE selects the initial BWP (BWP_ID=0).
In one embodiment, if no dynamic information for fast RLF recovery is included within the LTM candidate cell configuration, the UE may decode MIB or SIB1 and use cell-specific information included in this message to access the selected cell. Please note that during an LTM cell switch the UE is not required to decode MIB and/or SIB1 since it already has a dedicated configuration for that cell.

In one embodiment, the UE receives, in the LTM cell switch command (MAC CE), information for accessing the target cell, i.e. about a first target cell (1010) (e.g., TCI state ID, BWP ID) and, in addition, information for accessing the target cell for at least one more LTM candidate cell(s), e.g., for a second target cell (1016), such as i) a TA value, ii) UL grant for the complete message in target, iii) BWP ID of the BWP to be activated, iv) TCI state ID to be activated. When the UE detects a radio related failure (e.g., LTM cell switch failure) and selects a cell for which dynamic information has been included, the UE uses the information for accessing the target cell to access the selected cell e.g., applies the TA value associated to the selected cell and/or activates the indicated BWP ID, activates the indicated TCI ID, etc. Notice that it may be the case that some of the dynamic information are anyways available at the S-DU at the LTM cell switch, so that may be a matter of increasing the signaling of the LTM cell switch command.

In methods, transmitting the notification message may include one or more of the following steps.
In one embodiment, the notification message is a RRCReconfigurationComplete message of the stored LTM configuration that the UE transmits in the selected cell to complete the procedure. In one embodiment, the RRCReconfigurationComplete contains the LTM candidate configuration ID, identifying the configuration that the UE applied.
In another embodiment, the RRCReconfigurationComplete message contains the LTM candidate configuration ID of the cell toward which the LTM cell switch has previously failed and the LTM candidate configuration ID identifying the configuration that the UE applied after the fast RLF recovery. The CU or C-DU can use this information to release the failed LTM candidate cell configuration at the UE.
In another embodiment, such as when the UE has selected a beam, using the TCI state previously received to perform the early DL synchronization and the TA is valid and the UE did not perform random access in the selected cell, the UE indicates the selected beam in the notification message (such as selected SSB index or selected CSI-RS resource identifier).

In a dependent step, when a radio related failure is detected (e.g., timer T304 expires, Radio Link Failure, etc.), the UE initiates a re-establishment procedure. Before it starts timer T311 and starts cell selection, the UE determines whether it is configured or not with LTM e.g., whether it is configured with an IE for LTM configuration and/or with at least one LTM candidate configuration. When the UE is NOT configured with LTM, the UE performs one or more of the following actions:
reset MAC;
release the SpCell configuration (spCellConfig), if configured;
release the Secondary Cells (e.g., MCG SCell(s), if configured);
if MR-DC is configured, performing MR-DC release;
release delayBudgetReportingConfig, if configured and stop timer T342, if running;
release overheatingAssistanceConfig, if configured and stop timer T345, if running;
release idc-AssistanceConfig, if configured;
release btNameList, if configured;
release wlanNameList, if configured;
release sensorNameList, if configured;
release drx-PreferenceConfig for the MCG, if configured and stop timer T346a associated with the MCG, if running;
release maxBW-PreferenceConfig for the MCG, if configured and stop timer T346b associated with the MCG, if running;
release maxCC-PreferenceConfig for the MCG, if configured and stop timer T346c associated with the MCG, if running;
release maxMIMO-LayerPreferenceConfig for the MCG, if configured and stop timer T346d associated with the MCG, if running;
release minSchedulingOffsetPreferenceConfig for the MCG, if configured stop timer T346e associated with the MCG, if running;
release releasePreferenceConfig, if configured stop timer T346f, if running;
release onDemandSIB-Request if configured, and stop timer T350, if running;
release reference TimePreferenceReporting, if configured;
release sl-AssistanceConfigNR, if configured;
release obtainCommonLocation, if configured.

In one embodiment, the network controls whether the UE can perform fast recovery upon detecting a radio related failure. How the network controls the UE action can be in an explicit or implicit way.
In one example of the explicit way:
   the network sends an indication to the UE and this indication may comprise one or more of the following:
      whether fast recovery is allowed or not upon detecting a radio related failure;
      whether fast recovery is allowed or not only for a subset of LTM candidate cells and a list of these LTM candidate cells is provided;
      whether fast recovery is allowed or not only within a selected RAN area (RNA), tracking area (TA), or registration area (RA);
   the network sends an indication to the UE and this indication may be part of an LTM configuration. Alternatively, the indication may be part of the LTM candidate cell configuration itself. Alternatively, the indication may be broadcasted via system information.
In one example of the implicit way:
   the network indicates to the UE whether fast recovery could be performed upon detecting a radio related failure according to one or more of the following:
      via the presence or absence of a field that is LTM related. For instance, the presence or absence of a special configuration that is only used during the fast recovery upon detecting a radio related failure;
      if dynamic information that is generally part of an LTM cell switch are provided upfront to the UE;
      via the presence or absence of a timer configured and/or if its duration is set to a particular value. For instance, if the value of timer T311 is configured with a particular value that is used only when fast recovery is performed, then the UE understands that fast recovery is allowed.

In one embodiment, whether the UE can perform fast recovery upon detecting a radio related failure is up to the UE implementation. Alternatively, whether and when the UE should perform fast recovery upon detecting a radio related failure is hard-coded in the specification.

In one embodiment, the UE receives an LTM cell switch command indicating LTM cell switch towards a first target cell (1010), controlled by a first target node (1003). The first target node (1003) has become aware of that an LTM cell switch procedure has been triggered towards the first target cell 1010, for example, by the source network node 1002 has transmitted an indication, via the third network node 1006 to the first target network node, about the LTM execution. When the LTM cell switch procedure towards the first target cell fails, the UE detects radio related failure. The UE performs cell selection and selects the second target cell (1016). The UE determines whether or not the selected cell (1016) is an LTM candidate cell. If the second target cell is an LTM candidate cell the UE applies the LTM candidate cell configuration and uses the obtained information for accessing the target cell. The UE transmits a notification message (e.g., RRCReconfigurationComplete) to the in the second target cell 1016 to the second target node 1013. When the second target network node receives the notification, it determines that the UE performed cell switch towards the second target cell 1016. The second target network node transmits an indication to the third network node about an LTM cell switch to the second target cell 1016. The third network node becomes aware that the LTM cell switch procedure towards the first target cell failed but the UE successfully recovered to the second target cell. The third network node may then inform the source network node, e.g., by requesting a UE context modification or release and as result the serving network node may consider the LTM cell switch procedure as completed (even if it may not be aware towards which cell it was executed). The third network node may also inform the first target network node 1003 that the previously indicated LTM cell switch procedure triggered towards the first target cell 1010 was cancelled and/or request release of any resources that were allocated in the first target cell by the first target network node, e.g., TCI states, UL grants, should be released.

In one embodiment, the UE receives an LTM cell switch command indicating LTM cell switch towards a third target cell (1017), controlled by the second target node (1013). The second target node (1013) has become aware of that an LTM cell switch procedure has been triggered towards the third target cell 1017, for example, by the source network node 1002 has transmitted an indication, via the third network node 1006 to the second target network node, about the LTM execution. When the LTM cell switch procedure towards the third target cell fails, the UE detects radio related failure. The UE performs cell selection and selects the second target cell (1016). The UE determines whether or not the selected cell (1016) is an LTM candidate cell. If the second target cell is an LTM candidate cell the UE applies the LTM candidate cell configuration and uses the obtained information for accessing the target cell. The UE transmits a notification message (e.g., RRCReconfigurationComplete) to the in the second target cell 1016 to the second target node 1013. When the second target network node receives the notification, it determines that the UE performed cell switch towards the second target cell 1016 rather than the third target cell 1017. The second target network node transmits an indication to the third network node about an LTM cell switch to the second target cell 1016. The third network node becomes aware that the LTM cell switch procedure towards the third target cell failed but the UE successfully recovered to the second target cell. The third network node may then inform the source network node, e.g., by requesting a UE context modification or release and as result the serving network node may consider the LTM cell switch procedure as completed (even if it may not be aware towards which cell it was executed). The third network node may release resources that were allocated in the third target cell, e.g., TCI states, UL grants. Alternatively, the third network node explicitly requests those resources to be released.

Some embodiments of the present disclosure are discussed now.
A1. Methods for a User Equipment, UE, to perform recovery from a radio related failure, comprising the UE:
receiving at least one LTM candidate cell configuration,
detecting a radio related failure,
performing cell selection,
determining whether the selected cell (1016) is one of LTM candidate cells for which the UE has a stored LTM candidate cell configuration,
when the selected cell (1016) is one of LTM candidate cells:
applying the stored LTM candidate cell configuration associated to the selected cell,
obtain information for accessing the target cell (1016),
performing access in the target cell (1016) using the obtained information for accessing the target cell,
transmitting, to a second target network node, a notification message.
A2. The method in A1, wherein the UE performs an LTM cell switch to the target cell (1016)
A3. The method in A1, wherein the UE performs access in the target cell does not include a random access procedure after cell selection has been performed,
The method when the UE transmits UL data or signaling in the target cell without a prior random access procedure.
A4. The method in A1, wherein the UE performs access in the target cell includes a random access procedure after cell selection has been performed,
The method when the UE transmits UL data or signaling in the target cell after performing a random access procedure.
A5. The method in A1, wherein the UE performs access in the target cell in a beam,
The method, wherein the UE selects a beam using the obtained information for accessing the target cell, such as a TCI state.
B1. Methods for a source network node (source DU), such as a source gNB, a source DU or a source CU, to handle recovery of a UE from a radio related failure, comprising:
Sending to the UE at least one LTM candidate cell configuration, including a configuration of how the UE shall execute the LTM cell switch procedure after detecting a radio related failure.
B2. A method according to B1, wherein the configuration includes an indication for each LTM candidate cell configuration whether the UE is allowed to trigger the LTM cell switch based on detected radio related failure in the source cell.
B3. A method according to B2, wherein the indication applies to all LTM candidate cell configurations.
C1. Methods for a first target network node (first target DU), such as a target gNB, a target DU, or a target CU, to handle recovery of a UE from a radio related failure, comprising: receiving from the UE a notification message.
D1. Methods for a second target network node (second target DU), such as a target gNB, a target DU, or a target CU, controlling a second target cell, to handle recovery of a UE from a radio related failure, comprising:
receiving, from the UE, a notification message.
D2. The method in D1, wherein the notification message indicates the UE has performed an LTM cell switch to the second target cell.
D3. The method in D1 or D2, wherein the notification message includes an indication that the UE detected a radio related failure.
D4. The method in D1, D2 or D3, wherein the after receiving the notification message,
transmitting, to the third network node (1006), an indication that the UE has performed LTM cell switch.
D3. The method in D4, wherein the indication is an ACCESS SUCCESS message.
E1. Methods for a third network node (CU) (or serving network node), such as a (serving) Central Unit (CU), (serving) gNB-CU, to handle recovery of a UE from a radio related failure, comprising:
Receiving from the second target network node (1013) an indication that the UE has performed LTM cell switch.
D2. The method in D1, wherein the indication is an ACCESS SUCCESS message.

Sequence diagrams are now discussed.

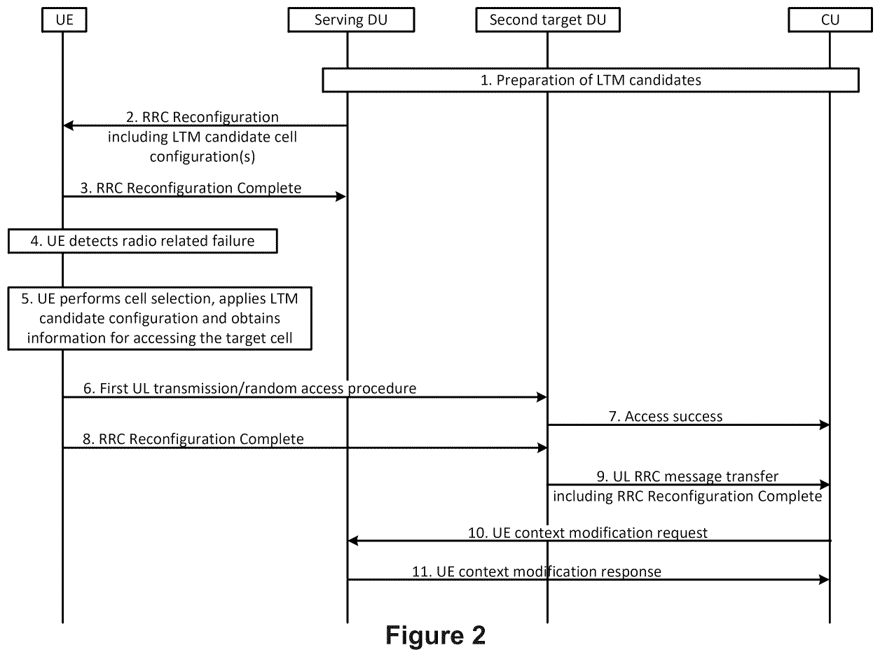

FIG. 2 illustrates a message sequence diagram associated with a radio related failure in one example of some embodiments. In this example, the UE detects a radio related failure and determines the selected cell is an LTM candidate cell. It then triggers an LTM cell switch towards the selected cell and uses information for accessing the target cell during the access.

Referring to FIG. 2, operations or actions in this example are as follows.
Step 2001. The network prepares LTM candidate cells for the UE. One of these cells is the second target cell (1016) controlled by a second target DU (1013).
Steps 2002-2003. The Serving DU (1002) configures the UE with LTM candidate cell configurations.
Step 2004. The UE detects a radio related failure, for example a radio link failure or failure to execute an LTM cell switch procedure to a first target cell (1010).
Step 2005. The UE performs cell selection and determines whether the selected cell is configured as an LTM candidate cell. In this example, the selected cell is the second target cell (1016) which is configured as an LTM candidate cell and the UE therefore executes an LTM cell switch towards the candidate cell by applying the corresponding LTM candidate cell configuration. The UE obtains information for accessing the target cell for the second target cell. When the obtained information includes for example TA and TCI state(s), the UE can skip random access and start UL transmission directly in the second target cell by using the obtained Information. Otherwise, the UE performs first a random access procedure.
Steps 2006-2007. The second target DU detects the first UL transmission from the UE and transmits an ACCESS SUCCESS message to the CU to indicate the arrival of the UE.
Steps 2008-2009. The UE transmits an RRCReconfigurationComplete message in the second target cell to the second target DU, which forwards the message to the CU.
Steps 2010-2011. Based on the reception of the ACCESS SUCCESS and RRCReconfigurationComplete messages, the CU determines that the UE has performed failure recovery to the second target cell. The UE then requests the serving DU (1002) to modify the UE context as the serving DU will not serve the UE any longer (but may be configured as an LTM candidate cell).

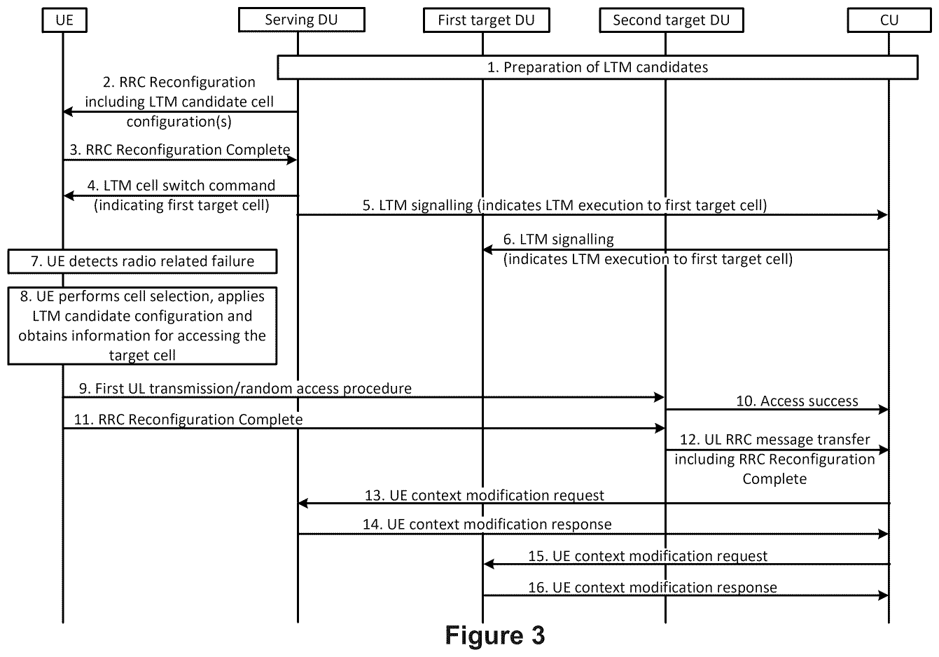

FIG. 3 illustrates a message sequence diagram associated with an LTM cell switch procedure in one example of some embodiments. In this example, an LTM cell switch procedure is triggered towards a first target cell and the UE detects a radio related failure (such as LTM cell switch procedure failure) and determines the selected cell is an LTM candidate cell. It then triggers an LTM cell switch towards the selected cell and uses information for accessing the target cell during the access.

Referring to FIG. 3, operations or actions in this example are as follows.
Step 3001. The network prepares LTM candidate cells for the UE. Among these cells are the first target cell (1010) controlled by a first target DU (1003) and the second target cell (1016) controlled by a second target DU (1013).
Steps 3002-3003. The Serving DU (1002) configures the UE with LTM candidate cell configurations.
Step 3004. The UE receives an LTM cell switch command indicating LTM cell switch to the first target cell.
Steps 3005-3006. The serving DU informs the CU about the execution which in turn informs the first target DU.
Step 3007. The UE detects a radio related failure, in this case failure to execute an LTM cell switch procedure to a first target cell (1010) (e.g., by timeout of the LTM supervision timer).
Step 3008. The UE performs cell selection and determines whether the selected cell is configured as an LTM candidate cell. In this example, the selected cell is the second target cell (1016) which is configured as an LTM candidate cell and the UE therefore executes an LTM cell switch towards the candidate cell by applying the corresponding LTM candidate cell configuration. The UE obtains information for accessing the target cell for the second target cell. When the obtained information includes for example TA and TCI state(s), the UE can skip random access and start UL transmission directly in the second target cell by using the obtained Information. Otherwise, the UE performs first a random access procedure.
Steps 3009-3010. The second target DU detects the first UL transmission from the UE and transmits an ACCESS SUCCESS message to the CU to indicate the arrival of the UE.
Steps 3011-3012. The UE transmits an RRCReconfigurationComplete message in the second target cell to the second target DU, which forwards the message to the CU.
Steps 3013-3014. Based on the reception of the ACCESS SUCCESS and RRCReconfigurationComplete messages, the CU determines that the UE has performed failure recovery to the second target cell. The UE then requests the serving DU (1002) to modify the UE context as the serving DU will not serve the UE any longer (but may be configured as an LTM candidate cell).
Steps 3015-3016. The CU informs the first target DU that the previously indicated LTM cell switch execution to the first target cell is cancelled and that the first target DU shall release any dynamic resources allocated for the UE, e.g., TCI state or UL grant.

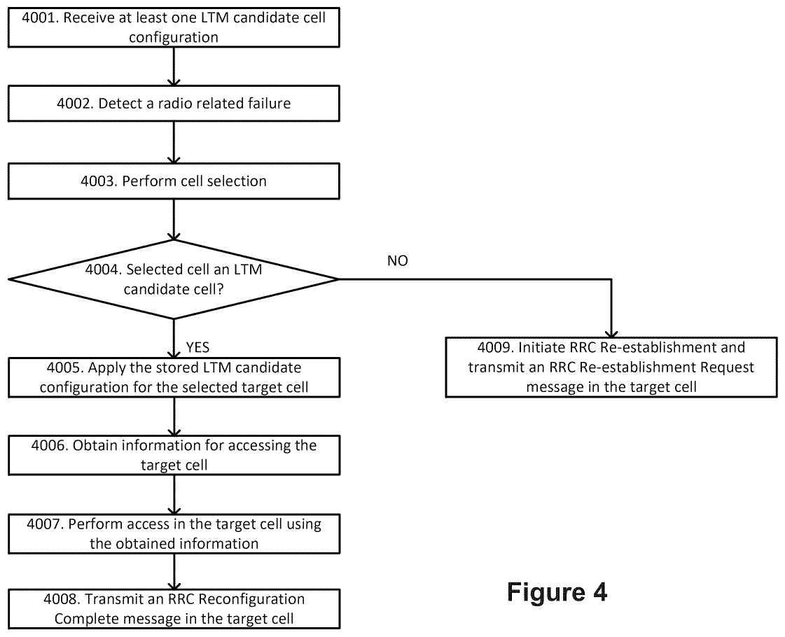

FIG. 4 illustrates operations performed by the UE in one example of some embodiments.

Referring to FIG. 4, operations performed by the UE in this example are as follows.
Step 4001. The UE receives at least one LTM candidate cell configuration.
Step 4002. The UE detects a radio related failure, such as a radio link failure or failure to execute an LTM cell switch procedure to a first target cell (1010).
Step 4003. The UE performs cell selection and, in this example, the selected cell is the second target cell (1016).
Step 4004. The UE determines whether the selected cell (1016) is an LTM candidate cell. If the selected cell is not an LTM candidate cell the UE goes to step 4008 otherwise it proceeds to the next step.
Step 4005. When the selected cell is an LTM candidate cell, the UE applies the stored LTM candidate cell configuration for the second target cell.
Step 4006. The UE obtains information for accessing the target cell for the second target cell, such as TA and TCI state(s),
Step 4007. By using the obtained information for accessing the target cell when performing access in the second target cell, the UE can skip random access and start UL transmission directly.
Step 4008. The UE transmits an RRCReconfigurationComplete in the second target cell.
Step 4009. When the selected cell is not an LTM candidate cell, the UE in this example initiates an RRC Re-establishment procedure and transmits an RRC Re-establishment Request message in the second target cell.

Specification text changes to Specification text changes to 3GPP TS 38.331 RRC protocol as follows:

```
[...]
5.3.7.3 Actions following cell selection while T311 is running
Upon selecting a suitable NR cell, the UE shall:
  1>ensure having valid and up to date essential system information as specified in clause
    5.2.2.2;
  1>stop timer T311;
  1>if T390 is running:
    2> stop timer T390 for all access categories;
    2>perform the actions as specified in 5.3.14.4;
  1>stop the relay (re)selection procedure, if ongoing;
  1>if the cell selection is triggered by detecting radio link failure of the MCG or re-
    configuration with sync failure of the MCG or mobility from NR failure, and
  1>if attemptCondReconfig is configured; and
  1>if the selected cell is not configured with CondEventT1, or the selected cell is configured
    with CondEventTl and leaving condition has not been fulfilled; and
  1>if the selected cell is one of the candidate cells for which the reconfigurationWithSync is
    included in the masterCellGroup in the MCG VarConditionalReconfig:
    2>if the UE supports RLF-Report for conditional handover, set the choCellId in the
    VarRLF-Report to the global cell identity, if available, otherwise to the physical cell
    identity and carrier frequency of the selected cell;
    2>apply the stored condRRCReconfig associated to the selected cell and perform actions
      as specified in 5.3.5.3;
  NOTE 1: It is left to network implementation to how to avoid keystream reuse in case
            of CHO based recovery after a failed handover without key change.
  1>if the selected cell is one of the candidate cells for which the UE has a stored LTM
    configuration in UE-LTM-Config within VarLTM-UE-Config:
    2>apply the stored LTM configuration in UE-LIM-Config within VarLTM-UE-Config
      associated to the selected cell and perform actions as specified in 5.3.5.3;
  NOTE 1: It is left to network implementation to how to avoid keystream reuse in case
            of LTM based recovery after a failed handover without key change.
  1>else:
    2>if UE is configured with attemptCondReconfig:
      3>reset MAC;
      3>release spCellConfig, if configured;
      3>release the MCG SCell(s), if configured;
      3>release delayBudgetReportingConfig, if configured and stop timer T342, if
        running;
      3>release overheatingAssistanceConfig , if configured and stop timer T345, if
        running;
      3>if MR-DC is configured:
        4>perform MR-DC release, as specified in clause 5.3.5.10;
      3>release idc-AssistanceConfig, if configured;
      3>release btNameList, if configured;
      3>release wlanNameList, if configured;
      3>release sensorNameList, if configured;
      3>release drx-PreferenceConfig for the MCG, if configured and stop timer T346a
        associated with the MCG, if running;
      3>release maxBW-PreferenceConfig for the MCG, if configured and stop timer
        T346b associated with the MCG, if running;
      3>release maxCC-PreferenceConfig for the MCG, if configured and stop timer T346c
        associated with the MCG, if running;
      3>release maxMIMO-LayerPreferenceConfig for the MCG, if configured and stop
        timer T346d associated with the MCG, if running;
      3>release minSchedulingOffsetPreferenceConfig for the MCG, if configured and stop
        timer T346e associated with the MCG, if running;
      3>release rlm-RelaxationReportingConfig for the MCG, if configured and stop timer
        T346j associated with the MCG, if running;
      3>release bfd-RelaxationReportingConfig for the MCG, if configured and stop timer
        T346k associated with the MCG, if running;
      3>release releasePreferenceConfig, if configured and stop timer T346f, if running;
      3>release onDemandSIB-Request if configured, and stop timer T350, if running;
      3>release referenceTimePreferenceReporting, if configured;
      3>release sl-AssistanceConfigNR, if configured;
      3>release obtainCommonLocation, if configured;
      3>release scg-DeactivationPreferenceConfig, if configured, and stop timer T346i, if
        running;
      3>release musim-GapAssistanceConfig, if configured and stop timer T346h, if
        running;
      3>release musim-Leave AssistanceConfig, if configured;
      3>release propDelayDiffReportConfig, if configured;
      3>release ul-GapFR2-PreferenceConfig, if configured;
      3>release rrm-MeasRelaxationReportingConfig, if configured;
      3>release maxBW-PreferenceConfigFR2-2, if configured;
      3>release maxMIMO-LayerPreferenceConfigFR2-2, if configured;
      3>release minSchedulingOffsetPreferenceConfigExt, if configured;
      3>suspend all radio bearers (RBs), and backhaul (BH) RLC channels for the
        integrated access and backhaul (IAB)-multi-transceiver (MT), except signalling
        radio bearer (SRB)0 and broadcast multicast RBs (MRBs);
    2>remove all the entries within the MCG VarConditionalReconfig, if any;
    2>for each measld, if the associated reportConfig has a reportType set to
      condTriggerConfig:
      3>for the associated reportConfigId:
        4>remove the entry with the matching reportConfigld from the reportConfigList
          within the VarMeasConfig;
      3>if the associated measObjectId is only associated to a reportConfig with reportType
        set to condTriggerConfig:
        4>remove the entry with the matching measObjectld from the measObjectList
          within the VarMeasConfig;
      3>remove the entry with the matching measId from the measIdList within the
        VarMeasConfig;
    2>release the PC5 RLC entity for SL-RLCO, if any;
    2>start timer T301;
    2>apply the default L1 parameter values as specified in corresponding physical layer
      specifications except for the parameters for which values are provided in SIB1;
    2> apply the default MAC Cell Group configuration as specified in 9.2.2;
    2>apply the CCCH configuration as specified in 9.1.1.2;
    2> apply the timeAlignmentTimerCommon included in SIB1;
    2>initiate transmission of the RRCReestablishmentRequest message in accordance with
      5.3.7.4;
  NOTE 2: This procedure applies also if the UE returns to the source PCell.
Upon selecting an inter-RAT cell, the UE shall:
  1>perform the actions upon going to RRC_IDLE as specified in 5.3.11, with release cause
    ‘RRC connection failure’.
[...]
```

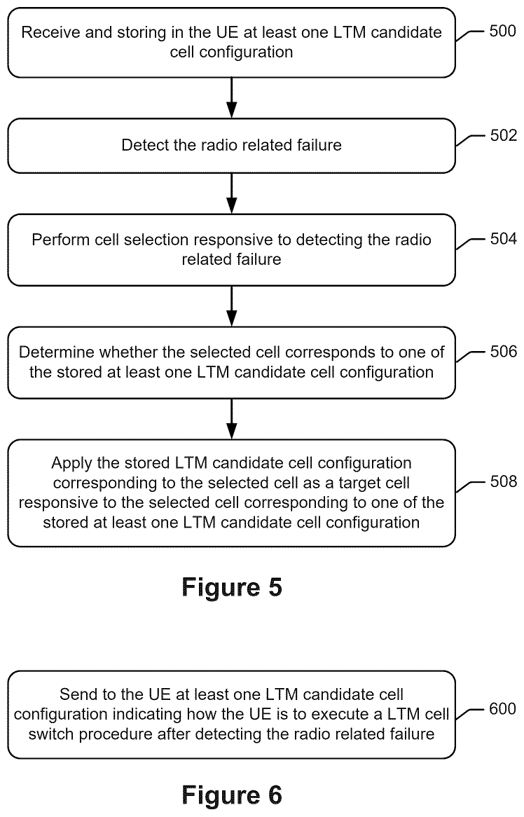

FIG. 5 illustrates a method performed by the UE in one example of some embodiments.

Referring to FIG. 5, operations performed by a UE in this example are as follows.

At block 500, the UE receives and stores in the UE at least one LTM candidate cell configuration.

At block 502, the UE detects a radio related failure, such as a radio link failure or failure to execute an LTM cell switch procedure to a first target cell (1010).

At block 504, the UE performs cell selection responsive to detecting the radio related failure, e.g., the selected cell is the second target cell (1016).

At block 506, the UE determines whether the selected cell corresponds to one of the stored at least one LTM candidate cell configuration.

At block 508, the UE applies the stored LTM candidate cell configuration corresponding to the selected cell as a target cell responsive to the selected cell corresponding to one of the stored at least one LTM candidate cell configuration.

FIG. 6 illustrates a method performed by a source network node to handle recovery of a UE from a radio related failure in one example of some embodiments.

Referring to FIG. 6, operations performed by the source network node to handle recovery of the UE from a radio related failure in this example are as follows.

At block 600, the source network node sends to the UE at least one LTM candidate cell configuration indicating how the UE is to execute a LTM cell switch procedure after detecting the radio related failure.

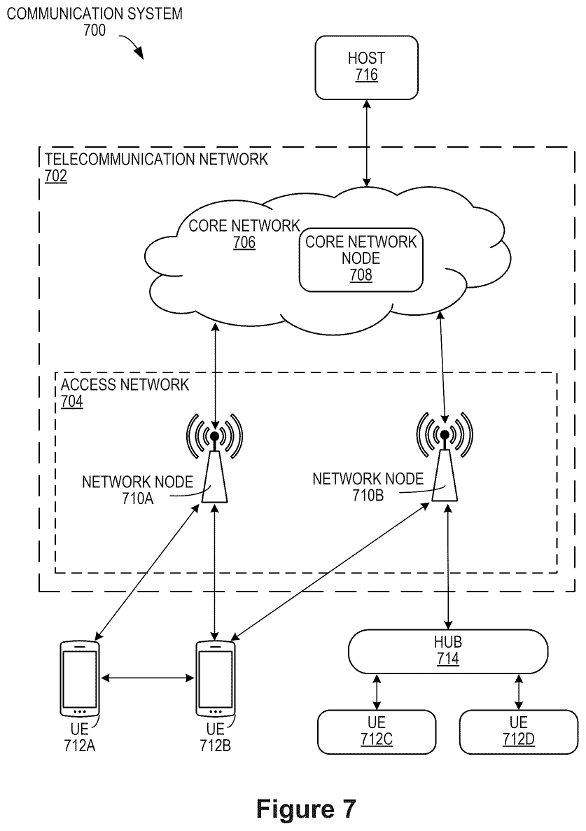

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub-that is, a hub whose primary function is to route communications to/from the UEs from/to the network node 710b. In other embodiments, the hub 714 may be a non-dedicated hub-that is, a device which is capable of operating to route communications between the UEs and network node 710b, but which is additionally capable of operating as a communication start and/or end point for certain data channels.

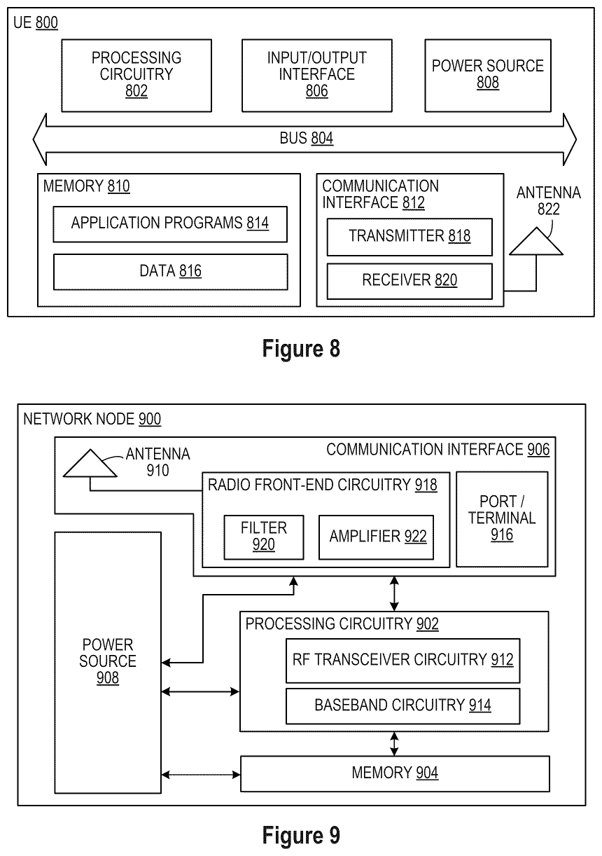

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M 2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. Memory 904 may be used to store any calculations made by the processing circuitry 902 and/or any data received via the communication interface 906. In some embodiments, the processing circuitry 902 and memory 904 are integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

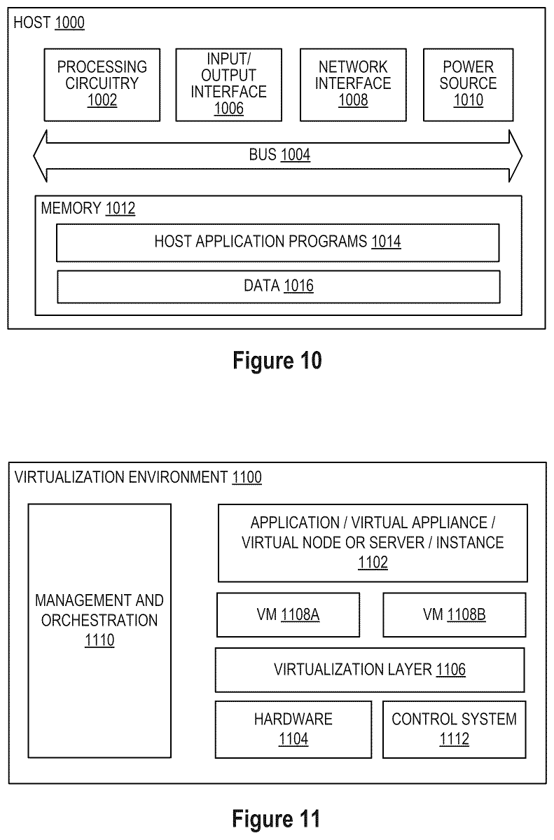

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

Memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

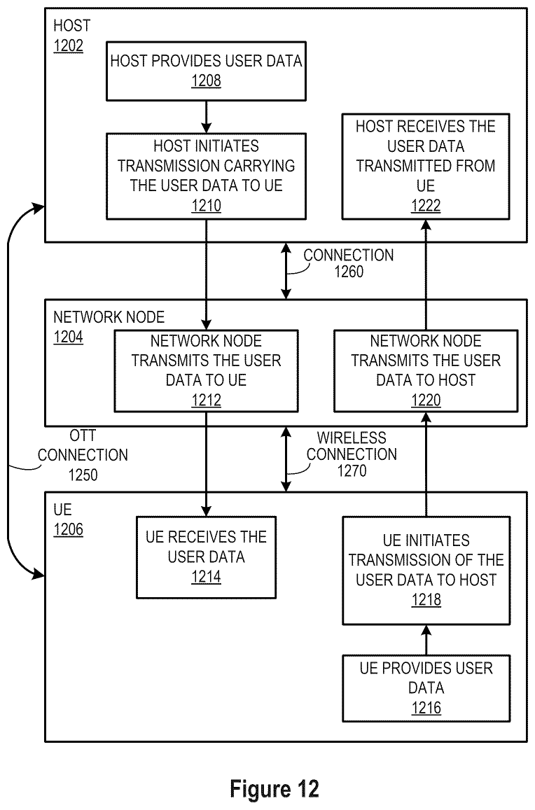

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve the data rate, latency, and power consumption of communications through the reduced signaling utilized for performing UE recovery from a radio related failure, and thereby provide benefits such as reduced user waiting time, relaxed restriction on file size for communications, better responsiveness, and extended battery lifetime.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc. ; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

A1. A method performed by a user equipment, UE, to perform recovery from a radio related failure, the method comprising:
   receiving (500) and storing in the UE at least one Level-1, L1, or Level-2, L2, triggered mobility, LTM, candidate cell configuration;
   detecting (502) the radio related failure;
   performing (504) cell selection responsive to detecting the radio related failure;
   determining (506) whether the selected cell corresponds to one of the stored at least one LTM candidate cell configuration; and
   responsive to the selected cell corresponding to one of the stored at least one LTM candidate cell configuration,
      applying (508) the stored LTM candidate cell configuration corresponding to the selected cell as a target cell.
A1.1. The method of any of the previous Group A embodiments, further responsive to the selected cell corresponding to one of the stored at least one LTM candidate cell configuration, the method comprising:
   obtaining information for accessing the target cell;
   performing access in the target cell using the obtained information; and
   transmitting a notification message to a network node.
A1.2. The method of any of the previous Group A embodiments, wherein the LTM candidate cell configuration comprises parameters in an information element, IE, CellGroupConfig defined for a candidate cell and/or parameters in an embedded RRC Reconfiguration defined for a candidate cell.
A2. The method of any of the previous Group A embodiments, further comprising:
   performing an LTM cell switch to the target cell.
A3. The method of any of the previous Group A embodiments, further comprising:
   performing access in the target cell without performing a random access procedure after cell selection has been performed.
A3.1 The method of the previous Group A embodiment, further comprising:
   transmitting uplink, UL, data or signaling in the target cell without performing the random access procedure after cell selection has been performed.
A4. The method of any of the previous Group A embodiments, further comprising:
   performing access in the target cell after performing a random access procedure after cell selection has been performed.
A4.1 The method of the previous Group A embodiment, further comprising:
   transmitting uplink, UL, data or signaling in the target cell after performing the random access procedure.
A5. The method of any of the previous Group A embodiments, further responsive to the selected cell corresponding to one of the stored at least one LTM candidate cell configuration, the method comprising:
   obtaining information for accessing the target cell;
   performing access in the target cell in a beam using the obtained information.
A5.1 The method of the previous Group A embodiment, further comprising:
   selecting the beam using the obtained information.
A5.2 The method of the previous Group A embodiment, further comprising:
   determining a Transmission Configuration Indication, TCI, state using the obtained information,
   wherein the beam is selected based on the TCI state.
A6. The method of any of the previous Group A embodiments, further comprising:
   providing user data; and
   forwarding the user data to a host via the transmission to a network node.

### Group B Embodiments

B1. A method performed by a source network node to handle recovery of a user equipment, UE, from a radio related failure, the method comprising:
   sending (600) to the UE at least one Level-1, L1, or Level-2, L2, triggered mobility, LTM, candidate cell configuration indicating how the UE is to execute a LTM cell switch procedure after detecting the radio related failure.
B1.1 The method of the previous Group B embodiment, wherein the candidate cell configuration comprises information to be used by the UE to execute the LTM cell switch procedure after detecting the radio related failure to access a target cell.
B2. The method of any of the previous Group B embodiments, wherein:
   the configuration comprises at least one indication for the at least one LTM candidate cell configuration indicating whether the UE is allowed to trigger execution of the LTM cell switch procedure based on detecting radio related failure.
B3. The method of the previous Group B embodiment, wherein:
   the indication indicating whether the UE is allowed to trigger execution of the LTM cell switch procedure based on detecting radio related failure, applies to all of the at least one LTM candidate cell configuration.
B4. The method of any of the previous Group B embodiments, further comprising:
   obtaining user data; and
   forwarding the user data to a host or the UE.

### Group C Embodiments

C1. A method performed by a first target network node to handle recovery of a user equipment, UE, from a radio related failure, the method comprising:
   receiving from the UE a notification message.
C2. The method of the previous Group C embodiment, wherein the first target node is a target gNB, a target distributed unit, or a target central unit.
C3. The method of any of the previous Group C embodiments, wherein the notification message indicates the UE has performed a Level-1, L1, or Level-2, L2, triggered mobility, LTM, cell switch to the first target cell.

### Group D Embodiments

D1. A method performed by a second target network node to handle recovery of a user equipment, UE, from a radio related failure, the method comprising:
   receiving from the UE a notification message.
D1.1 The method of the previous Group D embodiment and/or any of the previous Group C embodiments, wherein the second target node controls a second target cell and is a target gNB, a target distributed unit, or a target central unit.
D2. The method of any of the previous Group D embodiments and/or any of the previous Group C embodiments, wherein the notification message indicates the UE has performed a Level-1, L1, or Level-2, L2, triggered mobility, LTM, cell switch to the second target cell.
D3. The method of any of the previous Group D embodiments and/or any of the previous Group C embodiments, wherein the notification message comprises an indication that the UE detected a radio related failure.
D4. The method of any of the previous Group D embodiments and/or any of the previous Group C embodiments, further comprising:
   based on receiving the notification message, transmitting to a third network node an indication that the UE has performed a Level-1, L1, or Level-2, L2, triggered mobility, LTM, cell switch.
D5. The method of the previous Group D embodiment, wherein the indication is an ACCESS SUCCESS message.

### Group E Embodiments

E1. A method performed by a third target network node to handle recovery of a user equipment, UE, from a radio related failure, the method comprising:
   receiving from a second target network node an indication that the UE has performed a Level-1, L1, or Level-2, L2, triggered mobility, LTM, cell switch.
E2. The method of any of the previous Group E embodiments and/or any of the previous Group D embodiments and/or any of the previous Group C embodiments, wherein the indication is an ACCESS SUCCESS message.

### Group F Embodiments

F1. A user equipment, UE, for performing recovery from a radio related failure, comprising:
   processing circuitry configured to perform any of the steps of any of the Group A embodiments; and
   power supply circuitry configured to supply power to the processing circuitry.
F2. A network node for handling recovery of a user equipment, UE, from a radio related failure, the network node comprising:
   processing circuitry configured to perform any of the steps of any of the Group B, Group C, Group D, and/or Group E embodiments;
   power supply circuitry configured to supply power to the processing circuitry.
F3. A user equipment (UE) for performing recovery from a radio related failure, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
   a battery connected to the processing circuitry and configured to supply power to the UE
F4. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B, Group C, Group D, and/or Group E embodiments to transmit the user data from the host to the UE.
F5. The host of the previous embodiment, wherein:
   the processing circuitry of the host is configured to execute a host application that provides the user data; and
   the UE comprises processing circuitry configured to execute a client application associated with the host application to receive the transmission of user data from the host.
F6. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B, Group C, Group D, and/or Group E embodiments to transmit the user data from the host to the UE.
F7. The method of the previous embodiment, further comprising, at the network node, transmitting the user data provided by the host for the UE.
F8. The method of any of the previous 2 embodiments, wherein the user data is provided at the host by executing a host application that interacts with a client application executing on the UE, the client application being associated with the host application.
F9. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B, Group C, Group D, and/or Group E embodiments to transmit the user data from the host to the UE.
F10. The communication system of the previous embodiment, further comprising:
   the network node; and/or
   the UE.
F11. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B, Group C, Group D, and/or Group E embodiments to receive the user data from a user equipment (UE) for the host.
F12. The host of the previous 2 embodiments, wherein:
   the processing circuitry of the host is configured to execute a host application that receives the user data; and
   the host application is configured to interact with a client application executing on the UE, the client application being associated with the host application.
F13. The host of the any of the previous 2 embodiments, wherein the initiating receipt of the user data comprises requesting the user data.
F14. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B, Group C, Group D, and/or Group E embodiments to receive the user data from the UE for the host.
F15. The method of the previous embodiment, further comprising at the network node, transmitting the received user data to the host.
F16. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.
F17. The host of the previous embodiment, wherein the cellular network further includes a network node configured to communicate with the UE to transmit the user data to the UE from the host.
F18. The host of the previous 2 embodiments, wherein:
   the processing circuitry of the host is configured to execute a host application, thereby providing the user data; and
   the host application is configured to interact with a client application executing on the UE, the client application being associated with the host application.
F19. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
F20. The method of the previous embodiment, further comprising:
   at the host, executing a host application associated with a client application executing on the UE to receive the user data from the host application.
F21. The method of the previous embodiment, further comprising:
   at the host, transmitting input data to the client application executing on the UE, the input data being provided by executing the host application,
   wherein the user data is provided by the client application in response to the input data from the host application.
F22. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
F23. The host of the previous embodiment, wherein the cellular network further includes a network node configured to communicate with the UE to transmit the user data from the UE to the host.
F24. The host of the previous 2 embodiments, wherein:
   the processing circuitry of the host is configured to execute a host application, thereby providing the user data; and
   the host application is configured to interact with a client application executing on the UE, the client application being associated with the host application.
F25. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
F26. The method of the previous embodiment, further comprising:
   at the host, executing a host application associated with a client application executing on the UE to receive the user data from the UE.
F27. The method of the previous 2 embodiments, further comprising: at the host, transmitting input data to the client application executing on the UE, the input data being provided by executing the host application, wherein the user data is provided by the client application in response to the input data from the host application.
This listing of claims will replace all prior versions, and listings, of claims in the application:

1. A method performed by a user equipment, UE, to perform recovery from a radio related failure, the method comprising:
receiving and storing in the UE at least one Level-1, L1, or Level-2, L2, triggered mobility, LTM, candidate cell configuration;
detecting the radio related failure;
performing cell selection responsive to detecting the radio related failure;
determining whether the selected cell corresponds to one of the stored at least one LTM candidate cell configuration; and
responsive to the selected cell corresponding to one of the stored at least one LTM candidate cell configuration, applying the stored LTM candidate cell configuration corresponding to the selected cell as a target cell.

2. The method of claim 1, further responsive to the selected cell corresponding to one of the stored at least one LTM candidate cell configuration, the method comprising:
obtaining information for accessing the target cell;
performing access in the target cell using the obtained information; and
transmitting a notification message to a network node.

3. The method of claim 1, wherein the LTM candidate cell configuration comprises parameters in an information element, IE, CellGroupConfig defined for a candidate cell and/or parameters in an embedded RRC Reconfiguration defined for a candidate cell.

4. The method of claim 1, further comprising:
performing an LTM cell switch to the target cell.

5. The method of claim 1, further comprising:
performing access in the target cell without performing a random access procedure after cell selection has been performed.

6. The method of claim 1, further comprising:
transmitting uplink, UL, data or signaling in the target cell without performing the random access procedure after cell selection has been performed.

7. The method of claim 1, further comprising:
performing access in the target cell after performing a random access procedure after cell selection has been performed.

8. The method of claim 7, further comprising:
transmitting uplink, UL, data or signaling in the target cell after performing the random access procedure.

9. The method of claim 1, further responsive to the selected cell corresponding to one of the stored at least one LTM candidate cell configuration, the method comprising:
obtaining information for accessing the target cell; and
performing access in the target cell in a beam using the obtained information.

10. The method of claim 9, further comprising:
selecting the beam using the obtained information.

11. The method of claim 10, further comprising:
determining a Transmission Configuration Indication, TCI, state using the obtained information,
wherein the beam is selected based on the TCI state.

12. The method of claim 1, further comprising:
providing user data; and
forwarding the user data to a host via the transmission to a network node.

13. The method of claim 4, wherein if the LTM cell switch fails the UE re-initiates a re-establishment procedure and continues with the re-establishment procedure without attempting the LTM cell switch to the target cell again.

14. The method of claim 4, wherein the UE is allowed to try only once to execute LTM on the target cell after the radio related failure.

15. The method of claim 1, wherein the LTM candidate cell configuration indicates how the UE is to execute an LTM cell switch procedure after detecting the radio related failure.

16. The method of claim 15, wherein the LTM candidate cell configuration comprises information to be used by the UE to execute the LTM cell switch procedure after detecting the radio related failure to access the target cell.

17. The method of claim 15, wherein:
the LTM candidate cell configuration comprises at least one indication for the at least one LTM candidate cell configuration indicating whether the UE is allowed to trigger execution of the LTM cell switch procedure based on detecting radio related failure.

18. The method of claim 17, wherein:
the indication indicating whether the UE is allowed to trigger execution of the LTM cell switch procedure based on detecting radio related failure, applies to all of the at least one LTM candidate cell configuration.

19. A user equipment, UE, for performing recovery from a radio related failure, comprising:
a power supply circuitry configured to supply power to a processing circuitry; and
a processing circuitry configured to perform operations comprising:
receiving and storing in the UE at least one Level-1, L1, or Level-2, L2, triggered mobility, LTM, candidate cell configuration;
detecting the radio related failure;
performing cell selection responsive to detecting the radio related failure;
determining whether the selected cell corresponds to one of the stored at least one LTM candidate cell configuration; and
responsive to the selected cell corresponding to one of the stored at least one LTM candidate cell configuration,
applying the stored LTM candidate cell configuration corresponding to the selected cell as a target cell.

20. The UE of claim 19, further responsive to the selected cell corresponding to one of the stored at least one LTM candidate cell configuration, wherein the processing circuitry is configured to perform further operations comprising:
obtaining information for accessing the target cell;
performing access in the target cell using the obtained information; and
transmitting a notification message to a network node.

21-37. (canceled)
